(19) United States
(12) Patent Application Publication
(10) Pub. No.: US 2026/0216635 A1
(43) Pub. Date: Jul. 30, 2026

(54) METHOD FOR SEPARATING AN EXHAUST-GAS MIXTURE CONTAINING HYDROGEN CHLORIDE, HYDROGEN AND CHLOROSILANES

(71) Applicant: Wacker Chemie AG, Munich (DE)

(72) Inventors: Jens Felix Knoth, Munich (DE); Karone ASEERVATHAM, Munich (DE); Robert RING, Munich (DE); Martin ZETTL, Munich (DE)

(73) Assignee: Wacker Chemie AG, Munich (DE)

(21) Appl. No.: 19/148,699

(22) PCT Filed: Jan. 26, 2023
(86) PCT No.: PCT/EP2023/051875

§ 371 Date: Jul. 17, 2025

(51) Int. Cl. B01D 53/14

(52) U.S. Cl. CPC B01D 53/1456; B01D 53/1425; B01D 2252/10; B01D 2252/504; B01D 2257/2045; B01D 2257/553

(57) ABSTRACT

Process for separating an offgas mixture. The process includes providing an offgas mixture including hydrogen chloride, hydrogen and chlorosilanes. In a step a) the offgas is contacted with an absorbent in an absorption column at a temperature and a pressure, where the hydrogen chloride and the chlorosilanes are absorbed with formation of a laden absorbent, and a hydrogen-containing first gas phase is discharged. In a step b) desorbing a gas stream from the laden absorbent in a desorption column occurs.

The invention relates to a process for separating an offgas mixture containing hydrogen chloride, hydrogen and chlorosilanes.

Polycrystalline silicon (polysilicon) is starting material in the production of monocrystalline silicon by means of crucible pulling (Czochralski method) or zone melting (float-zone method). Monocrystalline silicon may be used in the form of wafers in the semiconductor industry for the manufacture of electronic components (chips). Additionally, polysilicon is needed for the production of multicrystalline silicon by means of block casting methods. Multicrystalline silicon may be used for the manufacture of solar cells.

Polysilicon may be produced by the Siemens process—a chemical vapour deposition process. This involves the heating of thin filament rods of silicon by direct passage of current in a reactor (Siemens reactor) and introduction of a reaction gas containing a silicon-containing component and hydrogen (H₂). The silicon-containing component used may comprise monosilane (SiH₄) or a halosilane of the general composition SiHₙX₄₋ₙ (n=0, 1, 2, 3; X=Cl, Br, I). It usually comprises a chlorosilane or chlorosilane mixture, more particularly trichlorosilane (SiHCl₃, TCS). The design of a typical Siemens reactor is described for example in US 2009/0136408 A1.

Another mode of production is the deposition of polysilicon on heated granular silicon particles in a fluidized bed reactor (granular method) as described for example in US 2013/0295385 A1.

Whatever the production method, the starting material used comprises silicon-containing components, usually TCS. As described for example in WO 2016/198264 A1, there are three methods by which TCS may be produced.

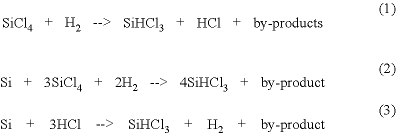

By-products arising may include further chlorosilanes, e.g. monochlorosilane (H₃SiCl), dichlorosilane (DCS, H₂SiCl₂), silicon tetrachloride (STC, SiCl₄) and also di- and oligosilanes. There may additionally be impurities present, in the form of by-products such as hydrocarbons, organochlorosilanes and metal chlorides.

Each of the three methods produces an offgas mixture which, after condensation of the chlorosilanes, contains not only hydrogen chloride (HCl) and H₂ but also traces of uncondensed chlorosilanes.

Furthermore, in the deposition of polysilicon by the Siemens process or granular method, an offgas mixture containing chlorosilanes, HCl and H₂ is formed.

For environmental and economic reasons, generally, the offgas is processed and H₂ and HCl are recovered. They may be passed back to the integrated production of polysilicon.

In addition to the recovery of H₂ by adsorption on activated carbon or other solids, as disclosed for example in US 2013/0011558 A1, it is possible when the fractions of HCl are relatively high to employ a combination of an adsorption and an absorption with desorption for the fractionation and purification of H₂ and HCl. A combination of this kind is described for example in US 2012/198998 A1. In the case of purely absorptive separation (comprising absorption and desorption), which is disclosed for example in CN 102431972 A and CN102614741 A, HCl is absorbed at low temperatures and elevated pressure in an absorbent. HCl is subsequently driven off again by temperature increase and/or pressure reduction in a column referred to as a desorption column.

A disadvantage of absorptive separation is that alongside HCl a significant quantity of H₂ is desorbed with the absorbent. In the desorption step, accordingly, H₂ is then likewise transferred into the gas phase and entrained with the HCl. In downstream process steps, the H₂ entrained in the HCl may have adverse effects, by—for example—promoting the formation of by-products, lowering the capacity and requiring higher compressor outputs.

CN 201567231 U discloses separation of HCl and H₂ after the desorption by condensation of the HCl. This approach, however, has the disadvantage that after the desorption, the offgas has to be condensed, using energy, and the liquid HCl removed, before being used further in the integrated production process, has to be evaporated again, using further energy.

The disadvantages described gave rise to the object on which the invention is based, which is that of providing a more efficient method for the purification of offgases from polysilicon production.

This object is achieved by a process for separating an offgas mixture containing HCl, H₂ and chlorosilanes, comprising the steps of:
a) contacting the offgas mixture with an absorbent in an absorption column at a temperature of −70 to −10° C. and a pressure of 0.5 to 2 MPa, where HCl and chlorosilanes are absorbed with formation of a laden absorbent, and a hydrogen-containing first gas phase is discharged at the top end of the absorption column;
b) desorbing a gas stream from the laden absorbent in a desorption column at a temperature of 50 to 150° C. and/or a pressure, reduced relative to step a), of 0.1 to 1 MPa. Here, after step a) and before step b), the laden absorbent is depressurized in at least one outgassing unit at a temperature increased relative to step a) and/or at a pressure reduced relative to step a) at a top end of the outgassing unit. By removal of a resultant second gas phase at the top end, further H₂ is removed from the laden adsorbent. The desorbed gas stream in step b) then has an H₂ fraction of ≤10 mol %, an HCl fraction of ≥89 mol % and a chlorosilane fraction of ≤1 mol %. The fractions add up to 100 mol %.

In the compositions of the gas phases and gas streams, impurities possibly introduced from previous process steps (e.g. N₂, CO₂, CH₄) are disregarded. They commonly account for not more than 0 to 6 mol % of the offgas mixture and are insignificant to the operability of the invention.

The desorbed gas stream preferably has an H₂ fraction of ≤8.2 mol %, an HCl fraction of ≥91.0 mol % and a chlorosilane fraction of ≤0.8 mol %.

The desorbed gas stream more preferably has an H₂ fraction of ≤7.3 mol %, an HCl fraction of ≥92.0 mol % and a chlorosilane fraction of ≤0.7 mol %.

The desorbed gas stream more particularly has an H₂ fraction of ≤6.5 mol %, an HCl fraction of ≥93.0 mol % and a chlorosilane fraction of ≤0.5 mol %.

The fractions of the components in the desorbed gas stream may be determined using a gas chromatograph (GC) with helium as carrier gas. As an alternative analytical technique, measurement may be made by means of Raman spectroscopy. The fraction of H₂ in HCl may be analysed, for example, by means of GC-TCD (thermal conductivity detector). In the determination, HCl is generally assumed to be the balance to 100%.

For the contacting in step a), the offgas mixture may be supplied via pipe conduits to the absorption column containing the absorbent. The absorption of HCl, chlorosilanes and, in very small quantity, H₂ as well takes place at least partially, preferably to the point of saturation of the absorbent. The absorbent is preferably a chlorosilane selected from the group of tetrachlorosilane, TCS, DCS and mixtures thereof.

The offgas mixture is typically contacted at a temperature of −60 to −20° C., preferably at −50 to −30° C., with the absorbent. The pressure here is preferably 1.2 to 1.8 MPa, more preferably 1.3 to 1.6 MPa.

The temperature at which the offgas mixture is contacted with the absorbent is determined as the entry temperature of the absorbent in the liquid phase. The pressure is commonly determined in the first gas phase over the absorbent. Temperature and pressure in the absorption column are each determined at the top end of said column.

The top end of a column or, in general, of a container/apparatus is typically the upper part, more particularly a cap or endpiece (lid). For example, the pressure may be determined by a manometer in an offgas conduit (through which the first gas phase is discharged) at the top end. The temperature may take place by a thermal sensor in an incoming pipe conduit at the top end.

For the depressurization of the laden absorbent, it may be supplied from the absorption column via pipe conduits to at least one outgassing unit. The depressurization in connection with the H₂-containing second gas phase formed in this case therefore comprises at least one intermediate step between steps a) and b).

The laden absorbent may also be depressurized in two or more, sequentially arranged outgassing units, where depressurization takes place in each outgassing unit and a downstream outgassing unit has a reduced pressure and/or an elevated temperature relative to an upstream outgassing unit. In other words, there is a pressure and/or temperature gradient between a first and a last outgassing unit (pressure decreasing, temperature increasing, in each case within the stated ranges).

With particular preference there is only one depressurization step between steps a) and b).

For the desorption of the gas stream in step b), the laden absorbent may be supplied from the outgassing unit (optionally from the last of two or more such units) via pipe conduits to the desorption column. The temperature here is determined in the still (at the low point) of the desorption column in the liquid phase (e.g. by means of temperature sensors) and the pressure is determined at the top end of the desorption column (e.g. by means of manometers in an offgas conduit) in the gas phase. The pressure in the desorption column is 0.1 to 1 MPa.

For the sequential process steps in the absorption column (step a)), the outgassing unit (intermediate step) and the desorption column (step b)), it is stipulated that there is a temperature gradient (increase) and/or a pressure gradient (decrease) within the stated pressure and temperature ranges between the individual steps.

It has been found that through the at least one-stage depressurization in at least one outgassing unit downstream of the absorption column, with high selectivity, H₂ entrained (absorbed) May be removed from the absorbent laden with HCl and chlorosilanes. Consequently, the H₂ fraction of the gas stream desorbed in step b) may be significantly reduced and hence the profitability of the process may be improved.

It has further emerged that a multi-stage depressurization generally affords few or no advantages over a one-stage depressurization.

The pressure at the top end of the outgassing unit is preferably reduced relative to step a) by 0.1 to 1.3 MPa, more preferably by 0.3 to 1.2 MPa, more particularly by 0.5 to 1.1 MPa (differential pressure).

The pressure at the top end of the outgassing unit is preferably 0.1 to 1.4 MPa, more preferably 0.2 to 1.2 MPa, more particularly 0.3 to 1.0 MPa.

The pressure at the top end of the outgassing unit may be established by means of a relative height difference between the outgassing unit and the absorption column by a hydrostatic pressure decrease via the liquid column. The outgassing unit may therefore be arranged at an elevated position by comparison with the absorption column. The pressure drop resulting from the height may lead to the desired differential pressure. In this way, savings can be made in terms of pressure reduction devices.

For example, an inlet opening intended for the supply of the laden absorbent may be arranged laterally on the outgassing unit 5 to 25 m, preferably 7 to 20 m, more preferably 10 to 18 m above an outlet opening intended for the laden absorbent in the absorption column.

The pressure may also be established by means of a valve-controlled volume expansion at an outlet opening of the absorption column.

Generally speaking, for effective separation of HCl and H₂, both the pressure and the temperature ought to be as low as possible within the stated ranges. At the same time, profitability requires direct incorporation of the outgassed H₂ into the relevant integrated system (e.g. polysilicon production) without additional compression/cooling.

The temperature of the laden absorbent in the outgassing unit is preferably −70 to −10° C., more preferably −60 to −20° C., more particularly −50 to −30° C.

The mean hydrodynamic residence time t of the laden absorbent in the outgassing unit is typically 1 to 40 s, preferably 2 to 30 s, more preferably 5 to 20 s, more particularly 6 to 15 s.

The mean hydrodynamic residence time t of the second gas phase in the outgassing unit is commonly 10 to 1150 s, preferably 25 to 850 s, more preferably 40 to 250 s, more particularly 45 to 150 s.

Furthermore, t of the absorbent in the absorption column may be 100 to 3500 s, preferably 200 to 3000 s, more preferably 250 to 2500 s.

τ is calculated by

$$τ = \frac{{V}_{R}}{\dot{V}} ,$$

where

V_{R}: fluid volume in the respective apparatus (e.g. volume in the outgassing unit or column that is filled with laden absorbent or gas mixture) in [m³].

\dot{V}: volume flow of the fluid (e.g. absorbent or offgas mixture) under operating conditions (p, T) in [m³/s].

τ for the absorbent in the absorption column is obtained via the assigned liquid volume and the volume flow of absorbent. Analogously, t in the gas phase is a function of the gas-filled volume and the gas volume flow.

Customary apparatus volumes for the absorption column and desorption column are 5 to 50 m³, with the fraction typically filled with absorbent being 10% to 80% of the volume. This thus gives the corresponding fluid volumes for gas phase and liquid phase.

The volume of the outgassing unit is preferably 0.01 to 5 m³. Here, the absorbent-filled fraction is customarily 10% to 70%.

As a result of the removal of the second gas phase at the top end of the outgassing unit, the volume flow discharged is preferably >30 Nm³/h, more preferably >75 Nm³/h, more particularly >125 Nm³/h.

The second gas phase removed from the outgassing unit typically has a hydrogen fraction of >60%, more preferably of >70%, more particularly of >80%.

The outgassing unit may be a separator, preferably a gravitational separator. With particular preference it is a vertical gravitational separator.

The apparatus volume is a function of the preferred residence times. In one preferred embodiment, the volume here is as low as is possible in the context of the stated residence times.

For example, the diameter of a typical vertical gravitational separator may be 300 to 1000 mm, preferably 400 to 900 mm, more preferably 500 to 800 mm.

A customary overall height for a vertical gravitational separator may be in a range from 900 to 3000 mm, preferably from 1400 to 2700 mm, particularly from 1800 to 2500 mm.

The ratio of diameter to overall height of the vertical gravitational separator may be 0.13 to 0.43, preferably 0.17 to 0.39, more preferably 0.21 to 0.35.

The lateral inlet opening of the vertical gravitational separator may be at a height which corresponds to 26% to 87%, preferably 43% to 78%, more preferably 56% to 74% of its overall height. The starting point for the measurement is the base of the separator.

The height of the vertical gravitational separator above its lateral inlet opening corresponds preferably to its diameter.

The liquid level (absorbent) in the outgassing unit may be determined and adjusted, for example, via guided radar measurement or via measurement by way of communicating pipes. Additionally, the liquid level may be determined via the pressure in the outgassing unit.

In one preferred embodiment, the diameter of the outlet of the outgassing unit is selected such that the dimensionless Froude number Fr is in the range from 0.2 to 4.0, more preferably from 0.5 to 3.0, more preferably from 0.8 to 2.0.

Fr is calculated by

$$Fr = \frac{{v}_{L}}{\sqrt{gD}} ,$$

where

ν_{L}: flow velocity of the laden absorbent at the outlet [m/s] (e.g. 0.4 to 3.0 m/s)

g: acceleration due to gravity (9.81 m/s²)

D: diameter of the drain conduit (e.g. 0.01 to 0.7 m)

Customary ratios of liquid level of the laden absorbent in the outgassing unit to diameter of the outlet are 0.7 to 10.0, preferably 0.9 to 9.0, more preferably 1.0 to 8.0.

The maximum mean gas velocity of the gas phase in the vertical gravitational separator may be ≤0.1 m/s, preferably ≤0.075 m/s, more preferably ≤0.05 m/s.

The maximum mean flow velocity of the laden absorbent in the vertical gravitational separator may be ≤0.2 m/s, preferably ≤0.15 m/s, more preferably ≤0.13 m/s.

The offgas mixture for treatment with the process of the invention may arise in an integrated plant for the production of polysilicon. The offgas mixture is formed more particularly in the production of TCS, in which case this process is preferably a production process from silicon, HCl and optionally H₂.

The process of the invention allows the H₂ content of the HCl to be reduced by ≥50%, preferably by ≥65%, more preferably by ≥80%. The H₂ removed is typically recycled and may be passed back to the integrated plant for the production of polysilicon. For example, it may be used for producing finely divided silica.

It is possible as a result to increase the capacity in the production of TCS (by reducing the fraction of H₂ and the associated increase in the throughput of HCl for constant reactor residence time). This produces an increased space-time yield. Alternatively, for the same space-time yield, the energy costs may be lowered, since the quantity of gas in circulation and hence the compressor output can be lowered (fraction of H₂ reduced).

In one preferred embodiment, the second gas phase from the outgassing unit is reunited with the offgas mixture before said mixture is supplied to the absorption column.

In a further embodiment, at least a part of the laden absorbent is passed via an outgassing unit, while the other part may be supplied directly to the desorption column.

There is typically an exchange of heat between the cold, laden absorbent and the heated absorbent after desorption, to minimize the energy requirement of the system at high throughputs. Furthermore, before entering the absorption column, the offgas mixture usually undergoes multi-stage cooling, by means, for example, of condensers and/or countercurrent assemblies and possibly further heat transfer pathways, in order to achieve the low temperature for the absorption in as energy-efficient a manner as possible. The fractionated gas streams from the outgassing unit and the desorption column also undergo multi-stage heat exchange in order to reduce energy losses. In principle, under economically relevant operating conditions, there is no complete separation of HCl and H₂.

A further aspect of the invention relates to an apparatus for separating an offgas mixture containing HCl, H₂ and chlorosilanes. The apparatus more particularly is suitable for implementing the process of the invention. The apparatus comprises components as follows:
an absorption column for contacting the offgas mixture with an absorbent at a temperature of −70 to −10° C. and a pressure of 0.5 to 2 MPa, where the absorption column comprises an outlet for discharging a hydrogen-containing first gas phase,
at least one outgassing unit downstream of the absorption column for depressurizing the absorbent laden with the offgas mixture in the absorption column, at a temperature increased relative to the temperature in the absorption column and/or at a pressure reduced relative to the pressure in the absorption column, where the outgassing unit comprises an outlet for discharging a hydrogen-containing second gas phase;
a desorption column downstream of the outgassing unit for desorbing a gas stream from the laden absorbent at a temperature of 50 to 150° C. and/or at a pressure, reduced relative to the absorption column, in a range from 0.1 to 1 MPa, where the desorption column comprises an outlet for discharging the desorbed gas stream.

Between absorption column and desorption column there may be two or more outgassing units arranged sequentially (in series). More preferably, however, only one outgassing unit is used.

The outgassing unit is preferably arranged separately from the absorption and desorption columns. This means more particularly that the outgassing unit is connected to the two columns substantially only via pipe conduits.

The outgassing unit may therefore be a component which, where appropriate, may also be inserted retrospectively into an existing offgas separation facility, without necessitating fundamental modifications to the facility as a whole.

In one preferred embodiment, a demister is provided at the top of the outgassing unit in order to prevent liquid being carried into the gas phase.

For further details of the individual components, reference may be made to the process description and to the description below of figures.

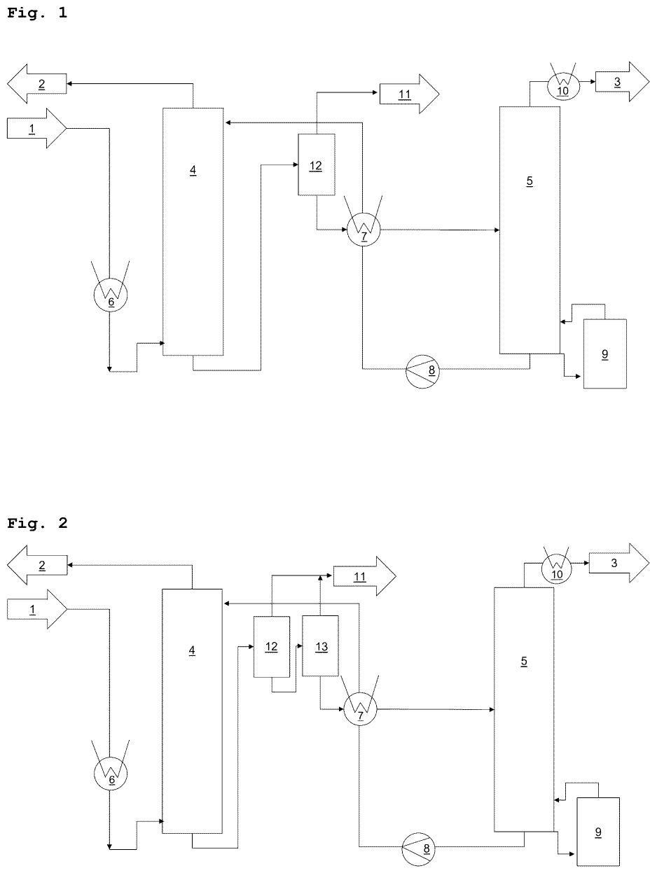

FIG. 1 shows a scheme of the process of the invention.

FIG. 2 shows a scheme of a variant of the process of the invention.

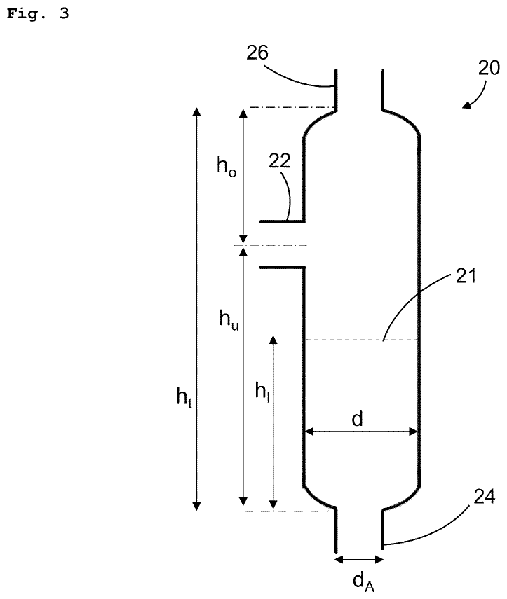

FIG. 3 shows an outgassing container.

FIG. 1 shows a scheme of the process of the invention. In this process, an offgas from polysilicon production, marked by the arrow 1, is passed via a condensation and heat exchange section 6 into an absorption column 4, where it is contacted with an absorbent (e.g. mixture of STC and TCS). The offgas contains, for example, 7 mol % of HCl, 92 mol % of H₂ and 1 mol % of uncondensed chlorosilanes (silane, monochlorosilane, DCS, TSC and STC). In the condensation and heat exchange section 6, it is compressed to 0.5 to 2.0 MPa and cooled to −70 to −10° C.

The first gas phase, discharged from the absorption column at its top end after the absorption, and marked by the arrow 2, contains customarily at least 95 mol % of H₂ and not more than 5 mol % of HCl.

The laden absorbent is supplied to a separate outgassing unit 12, with the pressure decreasing as a result of the height difference indicated, and with outgassing (second gas phase) taking place accordingly. The resultant second gas phase, which customarily has an H₂ fraction of at least 60 mol %, is discharged at the top end of the outgassing unit 12 (arrow 11) and may be passed back to an integrated plant for production of polysilicon or else used for producing finely divided silica.

The laden absorbent is subsequently supplied to a desorption column 5, where it first passes through a (or a plurality of) heat exchanger(s) (or countercurrent element(s)) 7 and then undergoes a further temperature increase in the desorption column 5 by means of a heater to 60 to 150° C. This temperature increase causes desorption of a gas stream, which is discharged at the top end of the desorption column 5 and is cooled by means of multi-stage heat exchange (via countercurrent elements and/or condensers 10) to around 5 to 35° C. This gas stream (arrow 3) contains customarily at least 89 mol % of HCl, not more than 10 mol % of H₂ and not more than 1 mol % of chlorosilanes (generally silane, monochlorosilane, DCS, TCS, STC).

Via the heat exchanger 7, the unladen absorbent recovered from the desorption column 5 is cooled (countercurrent principle) and returned to the absorption column 4. A pump 8 is provided for this return.

FIG. 2 shows a scheme of a different embodiment of the process of the invention, with an additional outgassing unit 13, in contrast to the configuration of FIG. 1. This unit 13 is downstream of a first outgassing unit 12. In both outgassing units 12, 13, outgassing takes place; in the additional outgassing unit 13, the pressure is customarily reduced relative to the outgassing unit 12, whereas the temperature level preferably remains constant.

FIG. 3 shows a vertical gravitational separator 20 as a specific embodiment of an outgassing unit. For the laden absorbent, the gravitational separator 20 has a lateral inlet opening (feed port) 22 and also a drain 24. At the top end of the gravitational separator 20 there is an outlet 26 for the second gas phase. The line 21 indicates the absorbent fill level. The following dimensions are marked with corresponding arrows:
hₜ: total height (wall thicknesses are generally negligible)
d: diameter
d_{A}: internal diameter of drain 24
hₗ: absorbent fill level (liquid level)
hᵤ: height below feed port 22
hₒ: height above feed port 22

### EXAMPLES

All of the examples were carried out at constant offgas composition:
HCl: 7.5 mol %
H₂: 89 mol %
Chlorosilanes (silane, monochlorosilane, DCS and STC): 3.5 mol %

The absorbent used was a mixture of STC (69 mol %) and TCS (31 mol %).

For all of the examples, the conditions set at the absorption column and the desorption column were as follows:
pressure (absorption column): 1.57 MPa
temperature (absorption column): −50° C.
pressure (desorption column): 0.36 MPa
temperature (desorption column): 90° C.

The measurements of the gas composition may be made via gas chromatography with thermal conductivity detector or via a RAMAN measurement. Temperatures were determined by means of a thermal sensor, pressures using a pressure transducer (e.g. capacitive or piezoresistive pressure transducer).

The outgassing unit (where used) had the same construction in all of the examples.

### Inventive Example 1

One-stage devolatilization took place in a vertical gravitational separator (see scheme in FIG. 1) at −40° C. (measured in the liquid phase in the feed for the absorbent). The pressure was adjusted through hydrostatic pressure decrease via positioning of the separator above the absorption column. The pressure was measured using a pressure transducer in the gas outlet at the top end of the separator: 0.6 MPa. The mean hydrodynamic residence time of the laden absorbent in the vertical gravitational separator was 8 s. The maximum mean flow velocity of the laden absorbent was 0.12 m/s. The maximum mean gas velocity of the gas phase was 0.015 m/s. A gas stream (second gas phase) of 146 Nm³/h with an H₂ fraction of 84.0 mol % was discharged from the separator. After desorption of the laden absorbent in the desorption column, an H₂ content of 1.77 mol % (reduction in H₂ slip by >82%) in the returned HCl was obtained.

### Comparative Example 1

The apparatus corresponded substantially to that from Inventive Example 1, but without an interposed gravitational separator. The parameters for absorption and desorption corresponded to those from Inventive Example 1. The H₂ content of the HCl without separate outgassing was 12.3 mol %.

### Inventive Example 2

The vertical gravitational separator is operated at 0.4 MPa and −50° C. The pressure is measured by means of a pressure transducer at the top of the outgassing container, in the gas flow discharge line, while the temperature is measured by means of a temperature sensor in the liquid phase, in the feed line for the laden absorbent. The mean hydrodynamic residence time of the laden absorbent in the vertical gravitational separator was 8 s. A gas stream of 183 Nm³/h was removed, discharged with an H₂ fraction of 83.8 mol % (arrow 11 in FIG. 1).

### Comparative Example 2

The vertical gravitational separator is operated at 0.4 MPa and 0° C. The mean hydrodynamic residence time of the laden absorbent in the vertical gravitational separator was 8 s. The pressure is measured by means of a pressure transducer at the top of the outgassing container, in the gas stream discharge line, while the temperature is measured by means of a temperature sensor in the liquid phase, in the feed line for the laden absorbent. A gas stream of 202 Nm³/h was removed. The H₂ fraction of the discharged gas phase in this case was only 46.2 mol %. The outgassing here is 202 Nm³/h, albeit with a lower H₂ fraction, meaning that a large quantity of HCl was passed back, undesirably.

It is apparent that under non-inventive temperature conditions (operation of the gravitational separator at 0° C.), the fraction of HCl obtained in the discharged gas stream is much higher (or the H₂ fraction is much lower), and so the objective of maximally effective removal of hydrogen is not achieved (not selective enough).

### Inventive Example 3

The vertical gravitational separator is operated at 0.4 MPa and −40° C. The mean hydrodynamic residence time of the laden absorbent in the vertical gravitational separator was 8 s. Pressure and temperature were determined as described.

A total gas stream of 186 Nm³/h with an H₂ fraction of 77.3 mol % was discharged from the gravitational separator.

### Comparative Example 3

The vertical gravitational separator is operated at 1.5 MPa and −40° C. The mean hydrodynamic residence time of the laden absorbent in the vertical gravitational separator was 8 s. Pressure and temperature were determined as described.

A total gas stream of 23 Nm³/h with an H₂ fraction of 92.4 mol % was discharged from the vertical gravitational separator.

It is apparent that under non-inventive pressure conditions (operation of the gravitational separator at 1.5 MPa), only a low hydrogen volume flow (calculated from gas volume flow multiplied by the hydrogen fraction) can be removed, meaning that the objective of maximally effective removal of H₂ is not achieved (volume flow too low).

The examples according to the invention show clearly that through reduced pressure at low temperatures it is possible selectively to discharge large amounts of H₂ and hence to greatly reduce the H₂ slip in the HCl.

1-15. (canceled)

16. Process for separating an offgas mixture, comprising:
providing an offgas mixture comprising hydrogen chloride, hydrogen and chlorosilanes;
step a) contacting the offgas mixture with an absorbent in an absorption column at a temperature of −70 to −10° C. and a pressure of 0.5 to 2 MPa, where the hydrogen chloride and the chlorosilanes are absorbed with formation of a laden absorbent, and a hydrogen-containing first gas phase is discharged;
step b) desorbing a gas stream from the laden absorbent in a desorption column at a temperature of 50 to 150° C. and/or a pressure, reduced relative to the step a), of 0.1 to 1 MPa;
wherein after the step a) and before the step b), the laden absorbent is depressurized in at least one outgassing unit at a temperature increased relative to the step a) and/or at a pressure reduced relative to the step a) at a top end of the outgassing unit and, by removal of a resultant second gas phase, hydrogen is removed from the laden absorbent, where the desorbed gas stream in the step b) has a hydrogen fraction of ≤10 mol %, a hydrogen chloride fraction of ≥89 mol % and a chlorosilane fraction of ≤1 mol %, where the mean hydrodynamic residence time of the laden absorbent in the outgassing unit is 1 to 40 s.

17. The process of claim 16, wherein the desorbed gas stream has a hydrogen fraction of ≤8.2 mol %, a hydrogen chloride fraction of ≥91.0 mol % and a chlorosilane fraction of ≤0.8 mol %.

18. The process of claim 16, wherein the laden absorbent is depressurized in two or more, sequentially arranged outgassing units, where depressurization takes place in each outgassing unit and a downstream outgassing unit has an increased temperature and/or a reduced pressure relative to an upstream outgassing unit.

19. The process of claim 16, wherein the pressure at the top end of the outgassing unit is reduced relative to the step a) by 0.1 to 1.3 MPa, preferably by 0.3 to 1.2 MPa, more preferably by 0.5 to 1.1 MPa.

20. The process of claim 16, wherein the pressure at the top end of the outgassing unit is 0.1 to 1.4 MPa, preferably 0.2 to 1.2 MPa, more preferably 0.3 to 1.0 MPa.

21. The proves of claim 16, wherein the pressure at the top end of the outgassing unit is established by means of a height difference between the outgassing unit and the absorption column by hydrostatic pressure decrease via the liquid column.

22. The process of claim 16, wherein the temperature of the laden absorbent in the outgassing unit is −70 to −10° C., preferably −60 to −20° C., more preferably −50 to −30° C.

23. The process of claim 16, wherein the mean hydrodynamic residence time of the laden absorbent in the outgassing unit is 2 to 30 s, preferably 5 to 20 s, more preferably 6 to 15 s.

24. The process of claim 16, wherein the removal of the second gas phase at the top end of the outgassing unit, a volume flow of >30 Nm³/h, preferably of >75 Nm³/h, more preferably of >125 Nm³/h is discharged.

25. The process of claim 16, wherein the second gas phase has a hydrogen fraction of >60%, preferably of >70%, more preferably of >80%.

26. The process of claim 16, wherein the outgassing unit is a separator, preferably a gravitational separator, more preferably a vertical gravitational separator.

27. The process of claim 26, wherein the maximum mean gas velocity of the gas phase in the vertical gravitational separator is ≤0.1 m/s, preferably ≤0.075 m/s, more preferably ≤0.05 m/s.

28. The process of claim 26, wherein the maximum mean flow velocity of the laden absorbent in the vertical gravitational separator is ≤0.2 m/s, preferably ≤0.15 m/s, more preferably ≤0.13 m/s.
